(19) United States
(12) Patent Application Publication
(10) Pub. No.: US 2015/0168612 A1
(43) Pub. Date: Jun. 18, 2015

(54) SUBSTRATE FOR DISPLAY DEVICE, METHOD FOR FABRICATING THE SAME, AND DISPLAY DEVICE INCLUDING THE SAME

(71) Applicant: SAMSUNG DISPLAY CO., LTD., Yongin-City (KR)

(72) Inventor: Jun Seok Lee, Incheon (KR)

(73) Assignee: SAMSUNG DISPLAY CO., LTD., Yongin-City (KR)

(21) Appl. No.: 14/263,938

(22) Filed: Apr. 28, 2014

(30) Foreign Application Priority Data
Dec. 18, 2013 (KR) 10-2013-0158411

(51) Int. Cl. G02B 5/02

(52) U.S. Cl. CPC G02B 5/0221; G02B 5/0268

(57) ABSTRACT

A substrate for a display device, a method for fabricating the substrate, and a display device including the substrate. In one embodiment of the present invention, a substrate for a display device includes a base substrate, and a plurality of first optical patterns positioned inside the base substrate, wherein the plurality of first optical patterns are arranged to be spaced apart from each other at equal intervals along a first direction that is parallel to one surface of the base substrate.

### CROSS-REFERENCE TO RELATED APPLICATION

This application claims priority to and the benefit of Korean Patent Application No. 10-2013-0158411, filed on Dec. 18, 2013, in the Korean Intellectual Property Office, the disclosure of which is incorporated herein in its entirety by reference.

### BACKGROUND

1. Field

The following description relates to a substrate for a display device, a method for fabricating the substrate, and a display device including the substrate.

2. Description of the Prior Art

A display device, such as a liquid crystal display, an electrophoretic display, an organic light emitting display, a FED (Filed Emission Display), a SED (Surface-conduction Electron-emitter Display), a plasma display, or a cathode ray tube display, includes at least one substrate. Various elements of a display device are mounted on such a substrate.

Recently, due to the demand for a slim display device, a substrate is required to have various optical characteristics in addition to support various elements. A general method for making a substrate having such optical characteristics is to pattern the substrate.

Generally, in order to pattern the substrate, a photolithography process is used. The photolithography process includes processing stages for spreading photoresist on the substrate, performing exposure and development with respect to the photoresist on the substrate, etching the exposed substrate, and cleaning the remaining photoresist. In addition, soft baking and hard baking processes may be inserted to strengthen the bonding force of the photoresist in between the processing stages.

Since the photolithography process includes several processing stages, deficiency rate of the last processing stage is heightened relative to (or depending on) deficiency rates of the respective processing stages. In addition, since various materials are required, the material cost is increased. Moreover, if both sides of the substrate are patterned, the complicated photolithography process should be repeated twice. Furthermore, since the photolithography process is a process for patterning the surface of the substrate, the surface of the substrate becomes uneven which causes difficulty in forming a structure (subsequently) on the substrate.

### SUMMARY

One aspect according to one or more embodiments of the present invention is directed toward a substrate for a display device, which includes a plurality of optical patterns regularly arranged therein.

Another aspect according to one or more embodiments of the present invention is directed toward a method for fabricating a substrate for a display device, which can easily form a plurality of optical patterns in a simple process and at low cost.

Still another aspect according to one or more embodiments of the present invention is directed toward a display device, which includes a substrate for the display device and the substrate includes a plurality of optical patterns regularly arranged therein.

Additional enhancements, subjects, and features of the invention will be set forth in part in the description which follows and in part will become apparent to those having ordinary skill in the art upon examination of the following or may be learned from practice of the invention.

According to one embodiment of the present invention, a substrate for a display device includes a base substrate, and a plurality of first optical patterns inside the base substrate, wherein the plurality of first optical patterns are spaced apart from each other at equal intervals along a first direction parallel to one surface of the base substrate.

An interface between each of the plurality of first optical patterns and the base substrate may include a concavo-convex shape.

A refractive index of the plurality of first optical patterns may be lower than a refractive index of the base substrate.

The refractive index of each of the plurality of first optical patterns may be increased from a center portion of each of the first optical patterns to an edge portion thereof.

A transparency of the plurality of first optical patterns may be lower than a transparency of the base substrate.

The transparency of each of the plurality of first optical patterns may be increased from a center portion of each of the first optical patterns to an edge portion thereof.

The plurality of first optical patterns may have a square shape.

The plurality of first optical patterns may be parallel to one surface of the base substrate, and spaced apart from each other at equal intervals along a second direction crossing the first direction.

The plurality of first optical patterns may be arranged in a matrix form.

The plurality of optical patterns may have a cylindrical shape.

The plurality of first optical patterns may be parallel to one surface of the base substrate, and extend along a second direction crossing the first direction.

The substrate for a display device may further include a plurality of second optical patterns spaced apart from each other at equal intervals along a second direction, extending along the first direction, and crossing the plurality of first optical patterns.

In another embodiment of the present invention, a method for fabricating a substrate for a display device includes arranging an optical interferometer on one surface of a transparent substrate, and forming a plurality of first optical patterns while moving the optical interferometer relatively to the transparent substrate, wherein the plurality of first optical patterns are spaced apart from each other at equal intervals along a first direction parallel to one surface of the transparent substrate.

The optical interferometer may irradiate interference laser light formed through overlapping of a plurality of laser lights onto an interior of the transparent substrate.

The interference laser light may form an interference wave in which peaks and valleys are repeated along the first direction, and a wavelength of the interference wave may be equal to a gap distance between the plurality of first optical patterns arranged in the first direction and adjacent to each other.

A moving direction of the optical interferometer may be substantially perpendicular to the first direction.

The optical interferometer may be repeatedly in on and off states in a set period.

The optical interferometer may be in an on state during movement of the optical interferometer.

The method for fabricating a substrate for a display device may further include forming a plurality of second optical patterns while moving the optical interferometer relatively to the transparent substrate along the first direction after the forming of the plurality of first optical patterns, wherein the plurality of second optical patterns may be parallel to the one surface of the transparent substrate and spaced apart from each other at equal (identical or same) intervals along a second direction perpendicular to the first direction.

In still another embodiment of the present invention, a display device including a first substrate, a display element on the first substrate, and a second substrate on the display element, wherein at least one of the first substrate and the second substrate includes a plurality of first optical patterns therein, and the plurality of first optical patterns are spaced apart from each other at equal intervals along a first direction parallel to one surface of the first substrate or the second substrate.

According to embodiments of the present invention, at least the following effects can be achieved.

That is, since optical patterns that perform the function of a scattering pattern are included inside the substrate for a display device, the utility of the even (flat) surface of the substrate for a display device may be increased.

In addition, a plurality of optical patterns can be easily formed in simple processes and at low cost.

Furthermore, since a plurality of optical patterns are formed only by an optical interferometer and a transparent substrate, the substrate or a structure to be subsequently formed on the substrate can be reduced or prevented from being polluted by other materials.

The effects according to the present invention are not limited to the contents as exemplified above, but more various effects are described in the specification of the present invention.

### BRIEF DESCRIPTION OF THE DRAWINGS

The above and other objects, features and enhancements of the present invention will be more apparent from the following detailed description taken in conjunction with the accompanying drawings, in which:

FIG. 1 is a perspective view of a substrate for a display device according to an embodiment of the present invention;

FIG. 2 is a plan view of the substrate for a display device of FIG. 1;

FIG. 3 is a cross-sectional view taken along the line II-II of FIG. 2;

FIGS. 4 to 6 are schematic views explaining a method for fabricating the substrate for a display device of FIG. 1;

FIG. 7 is a perspective view of a substrate for a display device according to another embodiment of the present invention;

FIG. 8 is a plan view of the substrate for a display device of FIG. 7;

FIG. 9 is a perspective view explaining a method for fabricating the substrate for a display device of FIG. 7;

FIG. 10 is a perspective view of a substrate for a display device according to still another embodiment of the present invention;

FIG. 11 is a plan view of the substrate for a display device of FIG. 10;

FIG. 12 is a perspective view explaining a method for fabricating the substrate for a display device of FIG. 10;

FIG. 13 is a perspective view of a substrate for a display device according to yet still another embodiment of the present invention;

FIG. 14 is a plan view of the substrate for a display device of FIG. 13;

FIG. 15 is a perspective view explaining a method for fabricating the substrate for a display device of FIG. 13;

FIG. 16 is a cross-sectional view of a display device according to an embodiment of the present invention;

FIG. 17 is a cross-sectional view of a display device according to another embodiment of the present invention; and

FIG. 18 is a cross-sectional view of a display device according to still another embodiment of the present invention.

### DETAILED DESCRIPTION

Enhancements and features of the present invention and methods of accomplishing the same may be understood more readily by reference to the following detailed description of embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the scope of the present invention will only be defined by the appended claims, and equivalents thereof. Thus, in some embodiments, known structures and devices are not shown in order to not obscure the description of the invention with unnecessary details. Like numbers refer to like elements throughout. In the drawings, the thickness of layers and regions are exaggerated for clarity.

It will be understood that when an element or a layer is referred to as being “on,” or “connected to” another element or layer, it can be directly on or connected to the other element or layer or intervening elements or layers may be present. In contrast, when an element is referred to as being “directly on” or “directly connected to” another element or layer, there are no intervening elements or layers present. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.”

Spatially relative terms, such as “below,” “beneath,” “lower,” “above,” “upper,” or the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Embodiments described herein will be described referring to plan views and/or cross-sectional views by way of ideal schematic views of the invention. Accordingly, the example views may be modified depending on manufacturing technologies and/or tolerances. Therefore, the embodiments of the invention are not limited to those shown in the views, but include modifications in configuration formed on the basis of manufacturing processes. Therefore, regions exemplified in the figures have schematic properties, and shapes of regions shown in the figures exemplify specific shapes of regions of elements and not limit the aspects of the invention.

Hereinafter, embodiments of the present invention will be described in more detail with reference to the accompanying drawings.

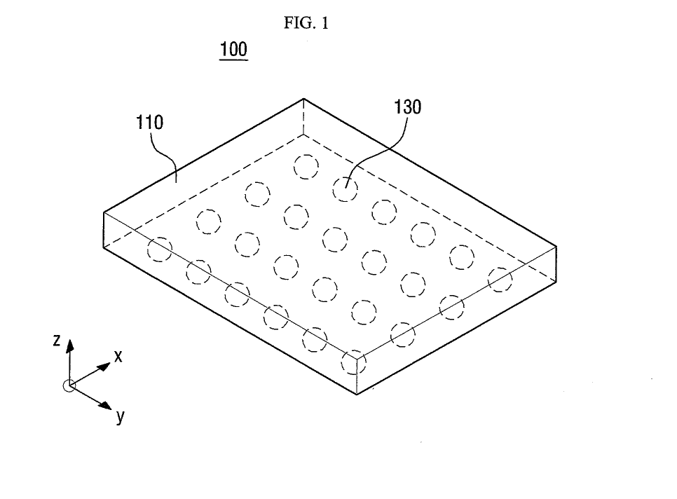

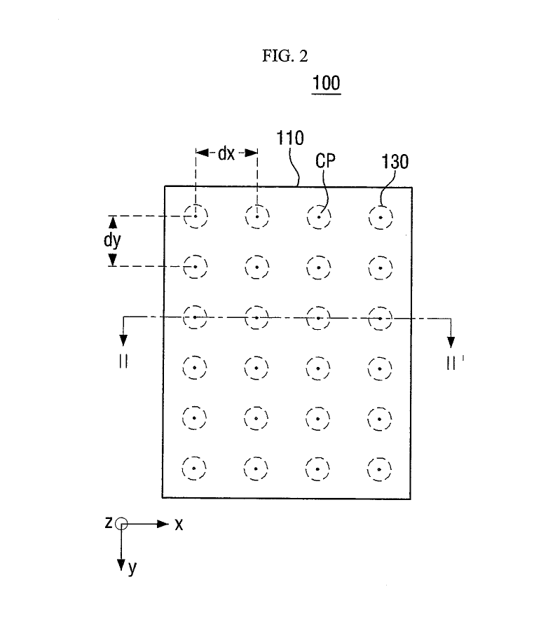

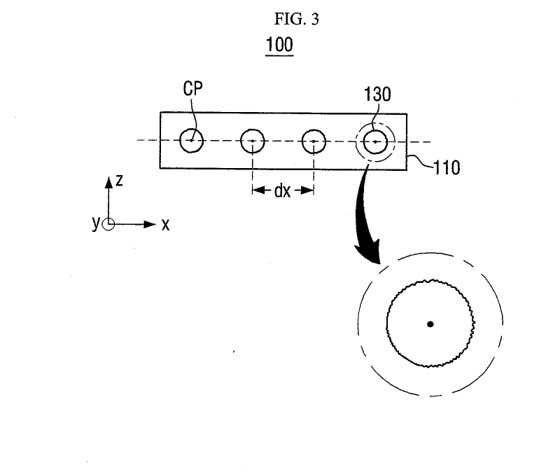

FIG. 1 is a perspective view of a substrate for a display device according to an embodiment of the present invention. FIG. 2 is a plan view of the substrate for a display device of FIG. 1, and FIG. 3 is a cross-sectional view taken along the line II-II of FIG. 2.

A display device that is described in the description may be any one of various kinds of display devices. In an example embodiment, the display device may be any one of a liquid crystal display, an electrophoretic display, an organic light emitting display, a FED (Filed Emission Display), a SED (Surface-conduction Electron-emitter Display), a plasma display, and a cathode ray tube display, but is not limited thereto. The display device may be one of various kinds of display devices.

A substrate 100 for a display device may be a substrate that is included in the above-described display device. In an example embodiment, the substrate 100 for a display device may be a substrate that is included in a display panel of the display device, but is not limited thereto. The substrate 100 for a display device may be a substrate that is included in a touch screen panel (TSP).

The substrate 100 for a display device may include a base substrate 110 and optical patterns 130.

The base substrate 110 may be a transparent insulating substrate. In an example embodiment, the base substrate 110 may be a glass substrate, a quartz substrate, or a transparent resin substrate. Further, the base substrate 110 may include a polymer material having flexibility and high heat resistance. In an example embodiment, the base substrate 110 may include any one of the materials selected from polyethersulphone (PES), polyacrylate (PAR), polyetherimide (PEI), polyethylene napthalate (PEN), polyethyleneterepthalate (PET), polyphenylene sulfide (PPS), polyarylate, polyimide (PI), polycarbonate (PC), cellulose triacetate, cellulose acetate propionate (CAP), poly(aryleneether sulfone), and a combination thereof.

The base substrate 110 may be in the shape of a cuboidal plate. For example, the base substrate 110 may include an upper surface, a lower surface, and a side surface. The upper surface and the lower surface may face each other. In an example embodiment, the upper surface and the lower surface may be in parallel to each other. In addition, the upper surface and the lower surface may have completely the same shape. Moreover, the upper surface and the lower surface may completely overlap each other. Furthermore, at least one of the upper surface and the lower surface may be even (flat). In an example embodiment illustrated in FIG. 1, both the upper surface and the lower surface are even, but are not limited thereto. At least one of the upper surface and the lower surface may be bent or may include a specific pattern. The side surface may connect the upper surface and the lower surface to each other. In an example embodiment, if the base substrate 110 is in the shape of a cuboidal plate, the side surface may be divided into four surfaces. That is, referring to FIG. 1, the side surface may include four surfaces that are positioned on upper, lower, left, and right sides (i.e., each of the four surfaces of the side surface corresponds to one of the four sides of the base substrate).

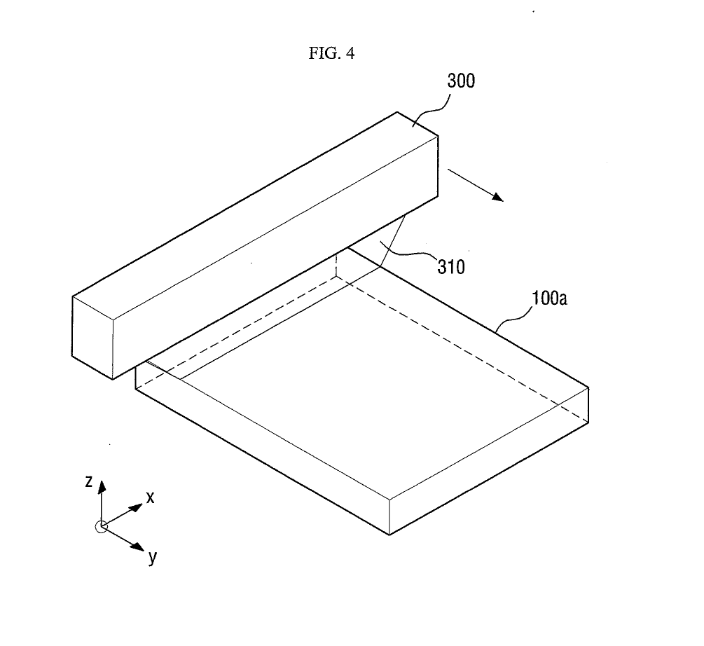

The base substrate 110 may be a part of a transparent substrate 110a (see FIG. 4) that is not modified by laser light 310 (see FIG. 4). That is, if an optical pattern 130 is formed inside the transparent substrate 100a by the laser light 310, the base substrate 110 may be a part of the transparent substrate 100a on which the optical pattern 130 is not formed. In other words, if it is assumed that the portion on which the optical pattern 130 is formed is a patterned portion, the base substrate 110 may be a non-patterned portion. The details thereof will be described later.

The optical patterns 130 may be positioned inside the base substrate 110. In an example embodiment, the optical pattern 130 may be schematically spherical, but is not limited thereto. The optical pattern 130 may have various shapes in accordance with the purpose of the substrate 100 for a display device. If the optical pattern 130 is schematically spherical, the optical pattern 130 may have a center point CP, and such a center point CP may be positioned at about ½ (half) point of the thickness of the base substrate 110. However, the position of the center point CP is not limited thereto, and the center point CP of the optical pattern 130 may be positioned at ⅓ or ¼ point of the thickness of the base substrate 110.

The surface of the optical pattern 130 may include a concavo-convex portion. In other words, an interface between the optical pattern 130 and the base substrate 110 may include convex portions and concave portions which are randomly arranged. In an example embodiment, the optical pattern 130 is a portion where the interior of the transparent substrate 100a is modified by heat generated by laser light 310, and thus the surface of the optical pattern 130 may not be uniform (i.e., may be rough).

As described above, since the surface of the optical pattern 130 includes the concavo-convex portion, the light that is irradiated onto the optical pattern 130 may be diffusely reflected. In other words, the light that is irradiated onto the optical pattern can be scattered. Here, since the substrate 100 for a display device which has the optical pattern 130 that performs the function of a scattering pattern, it is not necessary to form a separate scattering pattern on the surface of the substrate 100. Accordingly, a desired subsequent structure can be formed on an even surface of the substrate, and thus the utility of the substrate 100 for a display apparatus can be increased.

The refractive index of the optical pattern 130 may be lower than the refractive index of the base substrate 110. In an example embodiment, the refractive index of the optical pattern 130 may be lower than the refractive index of the base substrate 110 for about 0.02 on average, but is not limited thereto. The refractive index of the optical pattern 130 may be lower than the refractive index of the base substrate 110 for about 0.01 to 0.1 on average.

The refractive index of the optical pattern 130 may be heightened (increased) as going from the center portion CP of the optical pattern 130 to an edge portion thereof. That is, the refractive index of the optical pattern 130 may approach the refractive index of the base substrate 110 as going from the center point CP of the optical pattern 130 to the edge portion. Here, the edge portion of the optical pattern 130 may be the surface of the optical pattern 130, that is, the interface between the optical pattern 130 and the base substrate 110. In an example embodiment, the refractive index at the center point CP of the optical pattern 130 may be lower than that of the base substrate 110 by about 0.02. However, as going from the center point CP of the optical pattern 130 to the surface portion of the optical pattern 130, the refractive index is gradually increased, and the refractive index at the surface portion of the optical pattern 130 may be substantially the same as the refractive index of the base substrate 110. In this case, the average refractive index of the optical pattern 130 may be lower than that of the base substrate 110 by about 0.01. In another example embodiment, the refractive index at the center point CP of the optical pattern 130 may be lower than that of the base substrate 110 by about 0.04. However, as going from the center point CP of the optical pattern 130 to the surface portion of the optical pattern 130, the refractive index is gradually increased, and the refractive index at the surface portion of the optical pattern 130 may be substantially the same as the refractive index of the base substrate 110. In this case, the average refractive index of the optical pattern 130 may be lower than that of the base substrate 110 by about 0.02, but is not limited thereto. The refractive index of the optical pattern 130 may be adjusted through adjustment of the strength or irradiation time of laser light 310.

The transparency of the optical pattern 130 may be lower than the transparency of the base substrate 110. In an example embodiment, the optical pattern 130 may have light permeability (transmission) of a visible light region that is lower than that of the base substrate 110. However, the optical pattern may not be a pattern that completely intercepts (divert or obscure) the light, but may be a pattern that has opacity of a set or predetermined degree.

The opacity of the optical pattern 130 is heightened (becomes more transparent) as going from the center portion CP of the optical pattern 130 to the edge portion thereof. That is, the opacity of the optical pattern 130 may approach the opacity of the base substrate 110 as going from the center portion CP of the optical pattern 130 to the edge portion thereof. In an example embodiment, the opacity of the optical pattern 130 may be adjusted by setting the strength or irradiation time of the laser light 310 differently.

As described above, since the refractive index and/or transparency of the optical pattern 130 are lower than the refractive index and/or transparency of the base substrate 110 that is adjacent to the optical pattern 130, the traveling direction of the light that is irradiated onto the optical pattern 130 can be changed. That is, the light that is irradiated onto the optical pattern 130 can be scattered. As described above, since the optical pattern 130 that performs the function of a scattering pattern is included inside the base substrate 110, the surface of the base substrate 110 may be used for other purposes.

A plurality of optical patterns 130 may be provided. The plurality of optical patterns 130 may be arranged to be spaced apart from each other for a set or predetermined distance along a first direction that is parallel to one surface of the base substrate 110. That is, gap distances dx of the plurality of optical patterns 130, which are arranged in the first direction and are adjacent to each other, may be equal to each other. In an example embodiment, the first direction may be a direction that is parallel to a short side of the base substrate 110. In an example embodiment illustrated in FIG. 1, the first direction may be the x direction.

The plurality of optical patterns 130 may be arranged at equal intervals along a second direction that is parallel to one surface of the base substrate 110 and crosses the first direction. That is, gap distances dy of the plurality of optical patterns 130, which are arranged in the second direction and are adjacent to each other, may be equal to each other. In an example embodiment, the second direction may be a direction that is parallel to a long side of the base substrate 110. In an example embodiment illustrated in FIG. 1, the second direction may be the y direction. Further, the first direction and the second direction may be perpendicular to each other.

The plurality of optical patterns 130 may be arranged in a matrix form. In an example embodiment illustrated in FIGS. 1 and 2, the plurality of optical patterns 130 may be arranged in a 6×4 matrix form, but are not limited thereto. The plurality of optical patterns may be arranged in an n×m matrix form (where, n and m are integers that are equal to or larger than 2).

The plurality of optical patterns 130 may be arranged on the same plane. In an example embodiment of FIG. 3, the center points CP of the plurality of optical patterns 130 may be arranged on the same plane (the dotted portion). In an example embodiment, the center points CP of the plurality of optical patterns 130 may be formed at the same height based on the lower surface of the base substrate 110.

As described above, since the substrate 100 for a display device includes the plurality of optical patterns 130, the above-described light scattering function can be further increased. That is, since sufficient light scattering effect can be obtained by the plurality of optical patterns 130 included inside the base substrate 110 alone, it may not be necessary to form a separate scattering pattern on the surface of the base substrate 110. Accordingly, the utility of the substrate 100 for a display device can be increased.

FIGS. 4 to 6 are views explaining a method for fabricating a substrate 100 for a display device of FIG. 1. For convenience in explanation, same reference numerals are used for substantially the same elements as the elements illustrated in FIGS. 1 to 3, and duplicate explanation thereof will not be repeated.

First, referring to FIG. 4, a method for fabricating a substrate 100 for a display device may include arranging an optical interferometer 300 on (or over) one surface of a transparent substrate 100a; and forming a plurality of optical patterns 130 while moving the optical interferometer 300 relatively to the transparent substrate 100a.

Here, the transparent substrate 100a may be a transparent insulating substrate. In an example embodiment, the transparent substrate 100a may be a glass substrate, a quartz substrate, or a transparent resin substrate. Furthermore, the base substrate 110 may include a polymer material having flexibility and high heat resistance. Moreover, the transparent substrate 100a may be made of the same material as the base substrate 110. In addition, the transparent substrate 100a may be in the shape of a cuboidal plate.

The optical interferometer 300 may be an optical emission device using (utilizing) interference phenomenon by utilizing a plurality of laser lights 310. In an example embodiment, the optical interferometer 300 may emit two laser lights 310 and use (utilize) their interference phenomenon, but is not limited thereto. The optical interferometer 300 may emit three or more laser lights 310 and use (utilize) their interference phenomenon. Further, the optical interferometer 300 may be one using phase difference energy due to optical paths or one using a slit diffractive optical system, but the optical interferometer 300 is not limited thereto.

Further, the movement of the optical interferometer 300 relatively to the transparent substrate 100a may refer to the movement of the optical interferometer 300 or the transparent substrate 100a so that the optical interferometer 300 can scan one entire surface of the transparent substrate 100a. In an example embodiment, the movement of the optical interferometer 300 relatively to the transparent substrate 100a may refer to the movement of the optical interferometer 300 in the second direction in a state where the transparent substrate 100a is fixed. In another example embodiment, the movement of the optical interferometer 300 relatively to the transparent substrate 100a may refer to the movement of the transparent substrate 100a in the second direction when the optical interferometer 300 is fixed. However, the movement of the optical interferometer 300 relatively to the transparent substrate 100a is not limited thereto, and both the optical interferometer 300 and the transparent substrate 100a may move.

The optical interferometer 300 may irradiate the transparent substrate 100a with interference laser light that is formed through overlapping of a plurality of laser lights 310. In an example embodiment, the plurality of laser lights 310 and the interference laser light formed through overlapping thereof may be pulsed laser lights. Further, the plurality of laser lights 310 and the interference laser light that is formed through overlapping thereof may be nano-second laser lights, but are not limited thereto. The plurality of laser lights 310 and the interference laser light formed through overlapping thereof may be femto-second or pico-second laser lights. The plurality of laser lights 310 and the interference laser light formed through overlapping thereof may not exert an influence on the surface of the transparent substrate 100a, but may selectively modify only the interior of the transparent substrate 100a. Further, a region of the one surface of the transparent substrate 100a, onto which the plurality of laser lights 310 and the interference laser light formed through overlapping thereof are irradiated, may be a line rather than a surface. In an example embodiment, the line of the one surface of the transparent substrate 100a, onto which the plurality of laser lights 310 and the interference laser light formed through overlapping thereof are irradiated, may be parallel to the first direction.

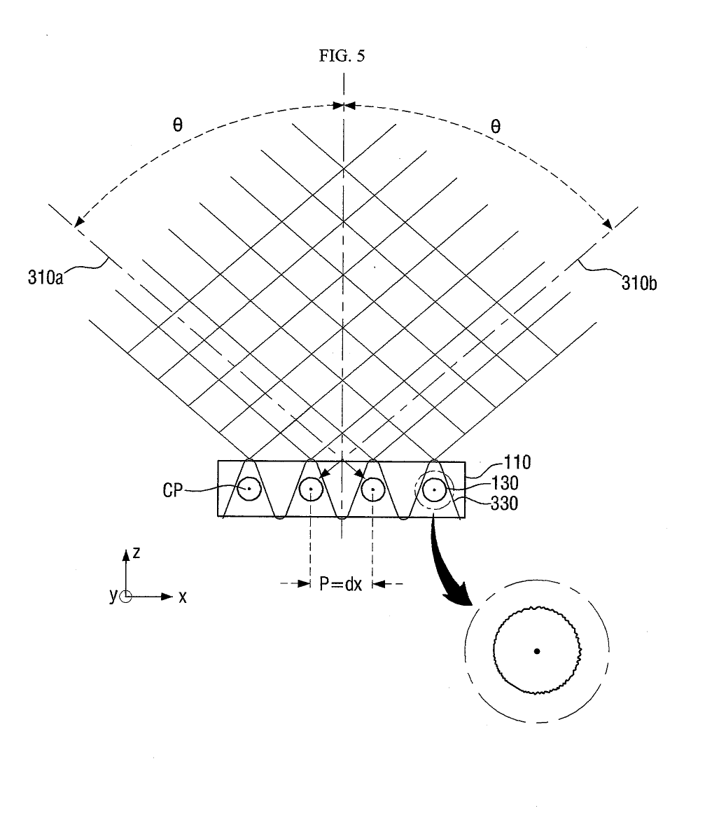

A process for forming a plurality of optical patterns 130 using an optical interferometer 300 will be described in more detail with reference to FIG. 5. Referring to FIG. 5, the plurality of laser lights 310 may include a first laser light 310a and a second laser light 310b. The first laser light 310a and the second laser light 310b may be irradiated in the direction of the transparent substrate 100a from a first portion and a second portion of the optical interferometer 300. In one embodiment, the incident angle θ of the first laser light 310a and the incident angle θ of the second laser light 310b are equal to each other.

The first laser light 310a and the second laser light 310b may overlap each other in a portion (location) that is adjacent to the transparent substrate 100a and may be transformed into the interference laser light. Here, in the portion where the first laser light 310a and the second laser light 310b overlap each other, a constructive interference may occur, in which the peak of the wave of the first laser light 310a and the peak of the wave of the second laser light 310b meet each other to increase the amplitude. Further, in the portion where the first laser light 310a and the second laser light 310b overlap each other, a destructive interference may occur, in which the valley of the wave of the first laser light 310a and the valley of the wave of the second laser light 310b meet each other to offset (e.g., almost offset) the amplitude. Due to such constructive interference and destructive interference, the interference laser light may include a new wave that is different from the waves of the first laser light 310a and the second laser light 310b, and this wave may be called an interference wave 330.

In the interference wave 330, the peaks and the valleys may be repeated along the first direction. The wavelength P of the interference wave 330 is expressed as in the following equation.

P=λ/2 sin θ

In the equation, λ denotes the wavelength of the first laser light 310a and the second laser light 310b, and θ denotes the incident angles of the first laser light 310a and the second laser light 310b.

Here, the wavelength P of the interference wave 330 may be equal to a gap distance dx of a plurality of optical patterns 130 which are arranged in the first direction and are adjacent to each other. That is, the plurality of optical patterns 130 may be formed to correspond to the peaks of the interference wave 330. Accordingly, by adjusting the wavelengths λ of the first laser light 310a and the second laser light 310b and/or the incident angles θ of the first laser light 310a and the second laser light 310b, the gap distance dx of the plurality of optical patterns 130 which are adjacent to each other in the first direction may be adjusted.

Further, the interference laser light may be focused onto a point that corresponds to ½ of the thickness of the transparent substrate 100a. The center point CP of the optical pattern 130 may be formed on the portion where the interference laser light is focused.

As described above, using the optical interferometer 300, the transparent substrate 100a may be divided into the base substrate 110 and the plurality of optical patterns 130.

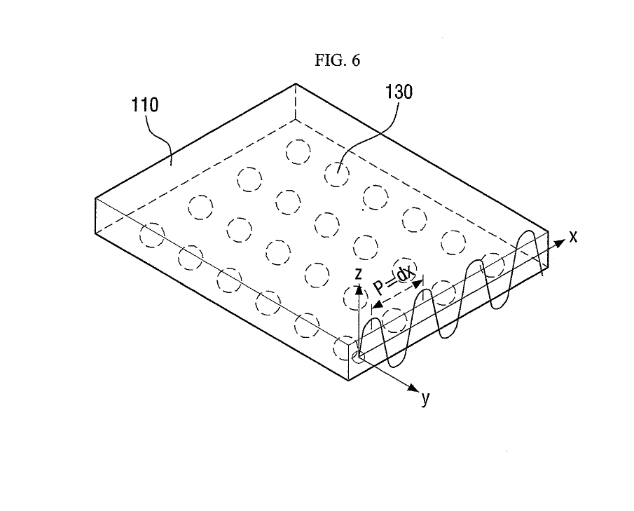

Hereinafter, the driving and movement of the optical interferometer 300 will be described in more detail with reference to FIG. 6. Referring to FIG. 6, the optical interferometer 300 that moves in the second direction may be repeatedly in on and off stages in a set or predetermined period. In an example embodiment, the optical interferometer 300 that is in an on state performs the spot irradiation of the laser light 310 onto the transparent substrate 100a, and then is in an off state while it moves by a set or predetermined distance. Thereafter, the optical interferometer 300 is changed to an on state to perform the spot irradiation of the laser light 310 onto the transparent substrate 100a, and then is changed to an off state while it moves again by the set or predetermined distance. Here, the set or predetermined distance, by which the interferometer 300 that is in an off state moves, may be equal to a gap distance dy of the plurality of optical patterns 130 which are arranged in the second direction and are adjacent to each other. That is, by adjusting the moving distance of the optical interferometer 300 that is in an off state, the gap distance dy of the plurality of optical patterns 130 in the second direction can be adjusted.

As described above, through the spot irradiation of the laser light 310 through the optical interferometer 300, the shape of the plurality of optical patterns 130 may become square.

According to the method for fabricating a substrate 100 for a display device according to an embodiment of the present invention as described above, by scanning the optical interferometer 300 only once, the plurality of optical patterns 130 that are arranged in a matrix form in the base substrate 110 can be easily formed. That is, the plurality of optical patterns 130 can be easily formed in a simple process and at low cost. Further, since the plurality of optical patterns 130 are formed only by the optical interferometer 300 and the transparent substrate 100a, the substrate or a structure to be formed on the substrate can be reduced or prevented from being polluted by other materials.

As described above, according to the substrate 100 for a display device and the fabricating method thereof according to an embodiment of the present invention, at least one optical pattern 130 is formed inside the base substrate 110, but is not limited thereto. The optical patterns 130 may be formed on the surface of the base substrate 110. That is, the surface of the substrate may be modified through adjustment of the point onto which the laser light 310 of the optical interferometer 300 is focused. In an example embodiment, if the surface of the substrate is modified through the optical interferometer 300, an antireflection function can be put onto the substrate itself instead of performing antireflection (AR) coating on the substrate.

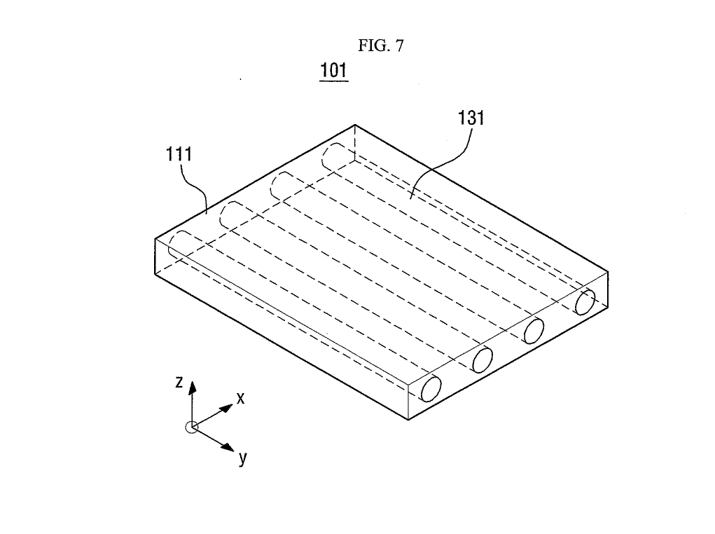

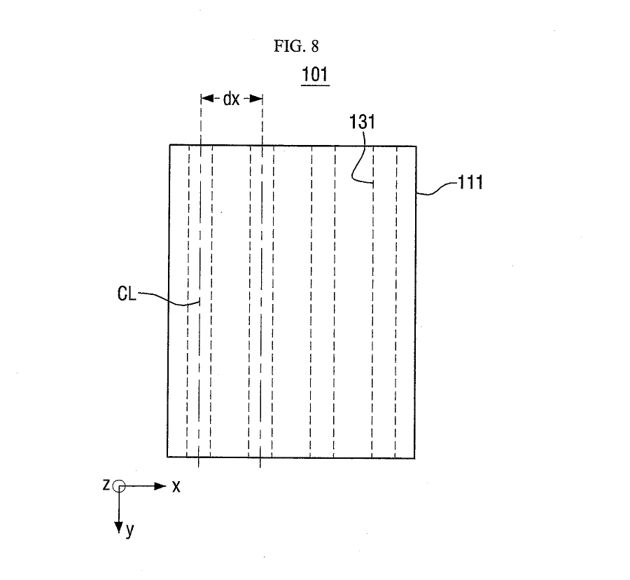

FIG. 7 is a perspective view of a substrate 101 for a display device according to another embodiment of the present invention, and FIG. 8 is a plan view of the substrate 101 for a display device of FIG. 7. For convenience in explanation, the same reference numerals are used for elements that are substantially the same as the elements illustrated in the above-described drawings, and duplicate explanation thereof may not be repeated.

Referring to FIGS. 7 and 8, a plurality of optical patterns 131 of a substrate 101 for a display device according to another embodiment of the present invention may be cylindrical. In other words, the plurality of optical patterns 131 may extend along the second direction. That is, the plurality of optical patterns 131 may be continuously formed along the second direction. The plurality of optical patterns 131 may have center lines, and a gap distance dx between the center lines of the adjacent optical patterns 131 may be a constant.

A base substrate 111 may surround such linear optical patterns 131, and end portions of the optical patterns 131 that are on two opposite side surfaces of the base substrate 111 may be exposed. However, the shape of the base substrate 111 is not limited thereto, and the base substrate 111 may completely surround the optical patterns without exposing parts of the optical patterns 131.

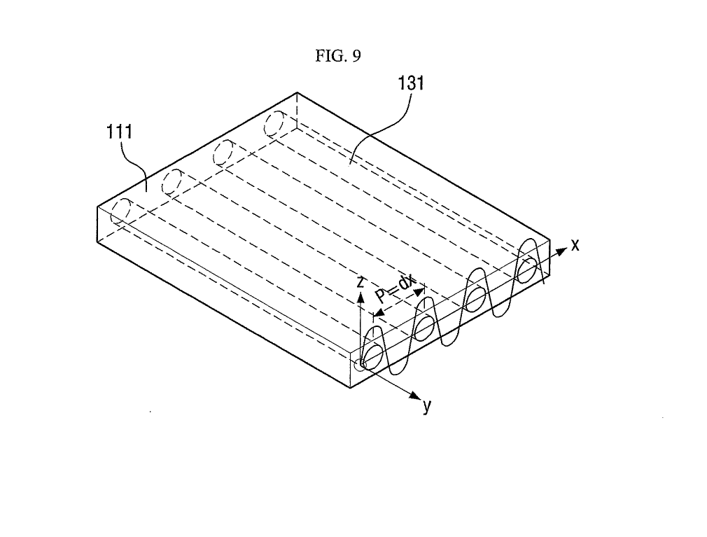

FIG. 9 is a perspective view explaining a method for fabricating the substrate 101 for a display device of FIG. 7. For convenience in explanation, the same reference numerals are used for elements that are substantially the same as the elements illustrated in the above-described drawings, and duplicate explanation thereof may not be repeated.

Referring to FIG. 9, unlike a previous embodiment of the present invention, the optical interferometer 300 may not be in an off state during the movement. In other words, the optical interferometer 300 may be always in an on state during the movement. As described above, if the optical interferometer 300 is always in an on state during the movement, linear optical patterns 131 may be formed along the movement direction of the optical interferometer 300.

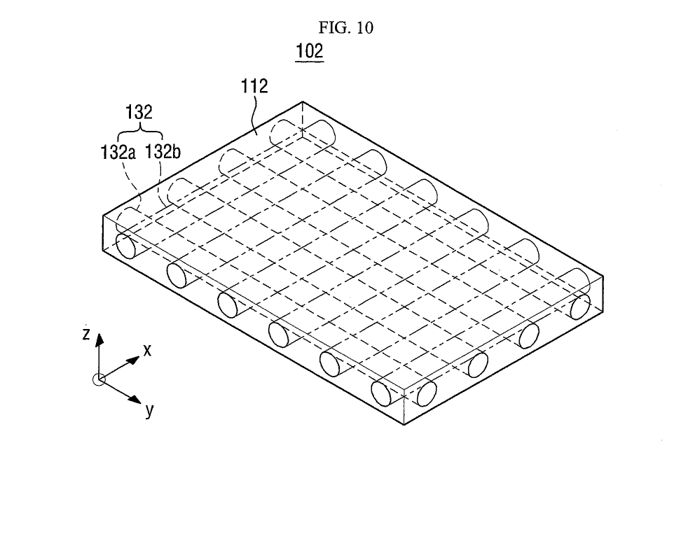

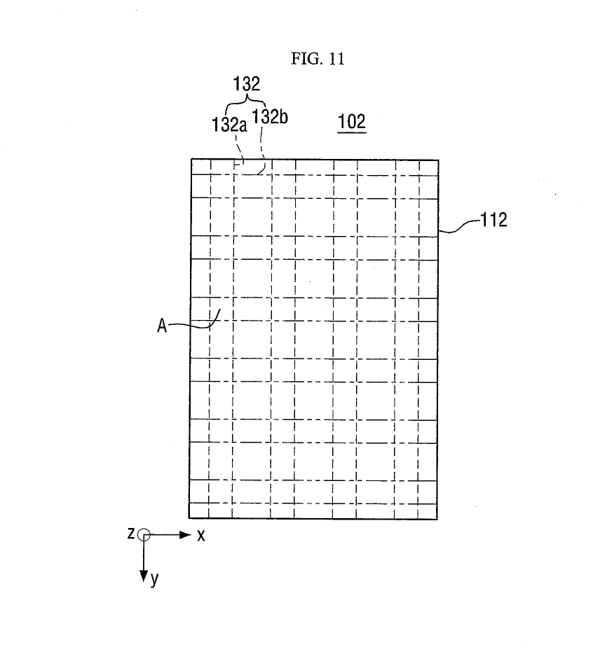

FIG. 10 is a perspective view of a substrate 102 for a display device according to still another embodiment of the present invention, and FIG. 11 is a plan view of the substrate 102 for a display device of FIG. 10. For convenience in explanation, the same reference numerals are used for elements that are substantially the same as the elements illustrated in the above-described drawings, and duplicate explanation thereof may not be repeated.

Referring to FIGS. 10 and 11, a substrate 102 for a display device according to still another embodiment of the present invention may include a base substrate 112 and optical patterns 132 that are positioned inside the base substrate 112, and the optical patterns 132 may include first optical patterns 132a and second optical patterns 132b.

The first optical patterns 132a may be substantially the same as the optical patterns 131 as illustrated in FIGS. 7 to 9.

The second optical patterns 132b may be spaced apart from each other at equal intervals along the second direction, and may extend along the first direction. Further, the second optical patterns 132b may cross the first optical patterns 132a. In an example embodiment, the first optical patterns 132a and the second optical patterns 132b may be formed on the same plane.

The refractive index of a portion A where the first optical pattern 132a and the second optical pattern 132b cross each other may be lower than the refractive index of a portion where the first optical pattern 132a or the second optical pattern 132b is positioned among a portion where the first optical pattern 132a and the second optical pattern 132b do not cross each other. Further, the transparency of the portion A where the first optical pattern 132a and the second optical pattern 132b cross each other may be lower than the transparency of the portion where the first optical pattern 132a or the second optical pattern 132b is positioned among the portion where the first optical pattern 132a and the second optical pattern 132b do not cross each other.

Four side surfaces of the base substrate 112 may expose all end portions of the first optical patterns 132a and the second optical patterns 132b. However, the shapes of the side surfaces of the base substrate 112 are not limited thereto, and the four side surfaces of the base substrate 112 may cover all the end portions of the first optical patterns 132a and the second optical patterns 132b.

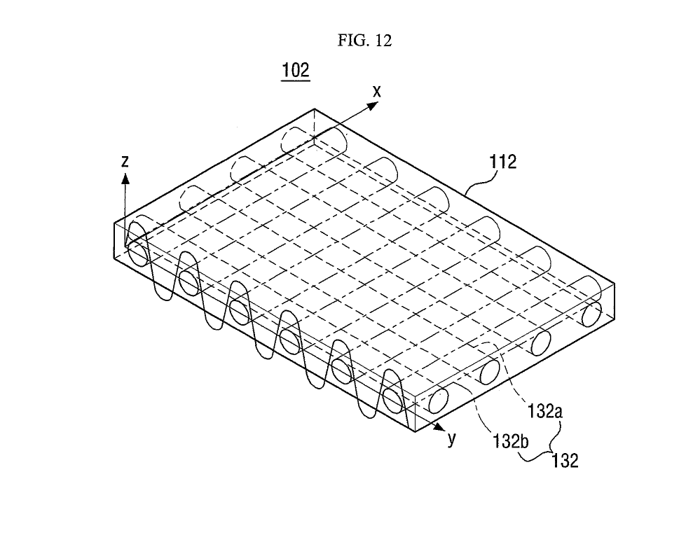

FIG. 12 is a perspective view explaining a method for fabricating the substrate 102 for a display device of FIG. 10. For convenience in explanation, the same reference numerals are used for elements that are substantially the same as the elements illustrated in the above-described drawings, and duplicate explanation thereof may not be repeated.

Referring to FIG. 12, after the first optical patterns 132a are formed through the process of FIG. 9, the second optical patterns 132b may be formed while the optical interferometer 300 moves in the first direction. At this time, the focusing points of the interference laser light of the optical interferometer 300 may be adjusted so that the second optical patterns 132b cross the first optical patterns 132a. As described above, since the modification by the laser light 310 is performed twice in the portion where the first optical pattern 132a and the second optical pattern 132b cross each other, the characteristic changes thereof may be greater than those in other portions.

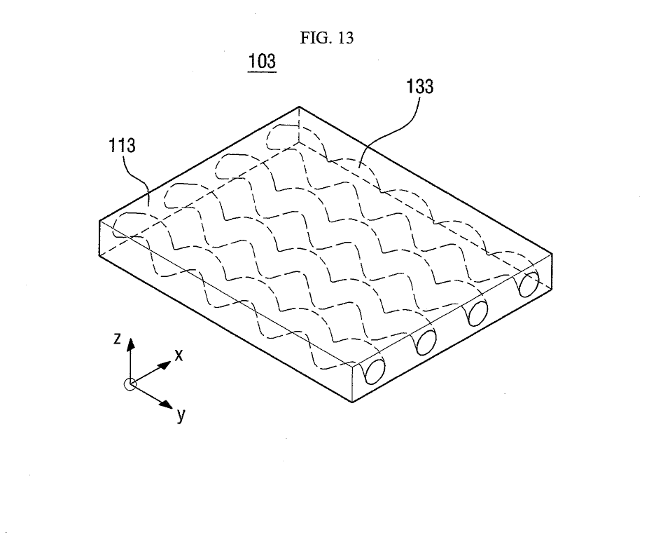

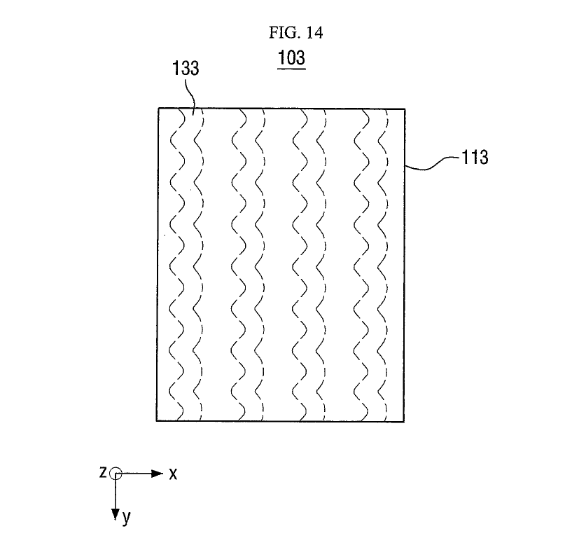

FIG. 13 is a perspective view of a substrate 103 for a display device according to yet still another embodiment of the present invention, and FIG. 14 is a plan view of the substrate 103 for a display device of FIG. 13. For convenience in explanation, the same reference numerals are used for elements that are substantially the same as the elements illustrated in the above-described drawings, and duplicate explanation thereof may not be repeated.

Referring to FIGS. 13 and 14, a substrate 103 for a display device according to yet still another embodiment of the present invention may include a base substrate 113 and a plurality of optical patterns 133 that are included in the base substrate 113, and the plurality of optical patterns 133 may have curved shapes. In an example embodiment, the plurality of optical patterns 133 may have wave shapes. In other words, the plurality of optical patterns 133 may have zigzag shapes.

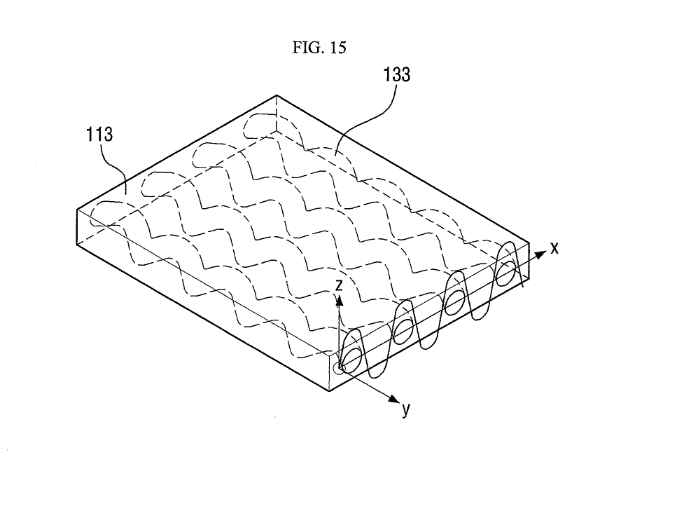

FIG. 15 is a perspective view explaining a method for fabricating the substrate 103 for a display device of FIG. 13. For convenience in explanation, the same reference numerals are used for elements that are substantially the same as the elements illustrated in the above-described drawings, and duplicate explanation thereof may not be repeated.

Referring to FIG. 15, in order to form a plurality of optical patterns 133 that have wave shapes, the moving path of the optical interferometer 300 may be adjusted. That is, the optical interferometer 300 may move in the second direction, but may have vibration in the first direction and in a direction opposite to the first direction. That is, the moving path of the optical interferometer 300 may correspond to the shape of the optical pattern 133. As described above, the shape of the plurality of optical patterns 133 may differ depending on the moving path and the driving method of the optical interferometer 300.

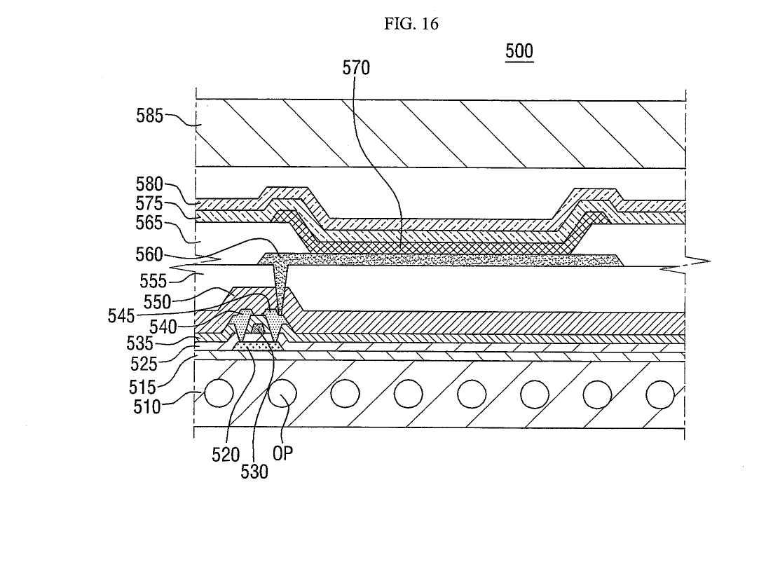

Hereinafter, a display device according to an embodiment of the present invention will be described with reference to FIG. 16. FIG. 16 is a cross-sectional view of a display device according to an embodiment of the present invention.

In the description, an organic light emitting display among various display devices is exemplified, but is not limited thereto. The present invention may be applied to other display devices, for example, a liquid crystal display or an electrophoretic display.

An organic light emitting display 500 according to an embodiment of the present invention may include a first substrate 510, a buffer layer 515, a semiconductor pattern 520, a gate insulating layer (e.g., film) 525, a gate electrode 530, an interlayer insulating layer 535, a source electrode 540, a drain electrode 545, an intermediate layer 550, a planarization layer 555, a first electrode 560, a pixel defining layer 565, an organic light emitting layer 570, a second electrode 575, a passivation layer 580, and a second electrode 585.

The first substrate 510 may be substantially the same as any one of the substrates 100, 101, 102, and 103 for a display device according to embodiments of the present invention as described above. That is, the first substrate 510 may include an optical pattern OP therein, and the optical pattern OP may be any one of the optical patterns 130, 131, 132, and 133 according to embodiments of the present invention.

The buffer layer 515 may be formed on the first substrate 510. The buffer layer 515 may reduce or prevent metal atoms or impurities from being diffused from the first substrate 510.

The semiconductor pattern 520 may be formed on the buffer layer 515. The semiconductor pattern 520 may be made of any one of amorphous silicon, non-crystalline silicon, poly silicon, oxide semiconductor, and a combination thereof.

The gate insulating layer 525 may be formed to cover the semiconductor pattern 520 on the buffer layer 515. The gate insulating layer 525 may be made of silicon oxide or metal oxide.

The gate electrode 530 may be formed on the gate insulating layer 525. The gate electrode 530 may be formed on a portion where the semiconductor layer is positioned with the gate insulating layer 525 in between. The gate electrode 530 may include a metal, an alloy, a metal nitride, a conductive metal oxide, and/or a transparent conductive material.

The interlayer insulating layer 535 may be formed on the gate insulating layer 525 to cover the gate electrode 530. The interlayer insulating layer 535 may be formed on the gate insulating layer 525 along a profile of the gate electrode 530 with a substantially uniform thickness. The interlayer insulating layer 535 may be made of a silicon compound.

The source electrode 540 and the drain electrode 545 may be formed on the interlayer insulating layer 535. The source electrode 540 and the drain electrode 545 may be spaced apart from each other at a set or predetermined intervals around the gate electrode 530, and may be arranged adjacent to the gate electrode 530. The source electrode 540 and the drain electrode 545 may penetrate the interlayer insulating layer 535 and the gate insulating layer 525 and may come in contact with the source region and the drain region, respectively. The source electrode 540 and the drain electrode 545 may include a metal, an alloy, a metal nitride, a conductive metal oxide, and/or a transparent conductive material.

The intermediate layer 550 may be formed to cover both the source electrode 540 and the drain electrode 545. The intermediate layer 550 may be formed with a thickness enough to cover the source electrode 540 and the drain electrode 545. The intermediate layer 550 may be made of silicon oxide, silicon nitride, or a combination thereof.

The planarization layer 555 may be formed on the intermediate layer 550. The planarization layer 555 may have a thickness that is enough to completely cover the intermediate layer 550. The planarization layer 555 may be formed using an organic material or an inorganic material.

The first electrode 560 may fill a hole that exposes a part of the drain electrode 545 formed on the planarization layer 555 to be connected to the drain electrode 545, and may be formed to extend from the surface of the planarization layer 555. The first electrode 560 may include a conductive material.

The pixel defining layer 565 may be formed on the planarization layer 555 and the first electrode 560. The pixel defining layer 565 may include at least one open region that exposes the first electrode 560. The pixel defining layer 565 may be formed using an organic material or an inorganic material. For example, the pixel defining layer 565 may include an organic material (such as a photoresist, a polyacryl-based resin, a polyimide-based resin, or an acryl-based resin), or an inorganic material (such as a silicon compound).

The organic light emitting layer 570 may be positioned on the open region that is defined by the pixel defining layer 565. Further, the organic light emitting layer 570 may be interposed between the first electrode 560 and a second electrode 575 to be described later in more detail. The organic light emitting layer 570 may have a multilayer structure that includes a light emitting layer EL, a hole injection layer HIL, a hole transport layer HTL, an electron transport layer ETL, and an electron injection layer EIL. If an electric field is applied to the organic light emitting layer 570, the organic light emitting layer 570 may emit light of a specific color.

The second electrode 575 may be formed on the organic light emitting layer 570 and the pixel defining layer 565 with a uniform thickness. The second electrode 575 may be made of a conductive material that is different from the first electrode 560. As described above, the first electrode 560, the organic light emitting layer 570, and the second electrode 575 may constitute a basic organic light emitting display element.

The passivation layer 580 may be formed on the second electrode 575. The passivation layer 580 may protect structures provided on lower portions of the second electrode 575 and the second electrode 575 from an external environment. The passivation layer 580 may be made of a silicon compound.

The second substrate 585 may be formed on the passivation layer 580. The second substrate 585 may come in contact with the passivation layer 580, but as illustrated in the drawing, may be positioned to be spaced apart from each other for a set or predetermined distance. Like the passivation layer 580, the second substrate 585 may also protect an organic light emitting display element from an external environment.

The organic light emitting display 500 according to an embodiment of the present invention as described above may be a bottom emission organic light emitting display. That is, light emitted from the organic light emitting layer 570 may be output to an outside through the first substrate 510. Here, since the light may be scattered by the plurality of optical patterns OP formed inside the first substrate 510, the side viewing angle of the organic light emitting display 500 may be improved.

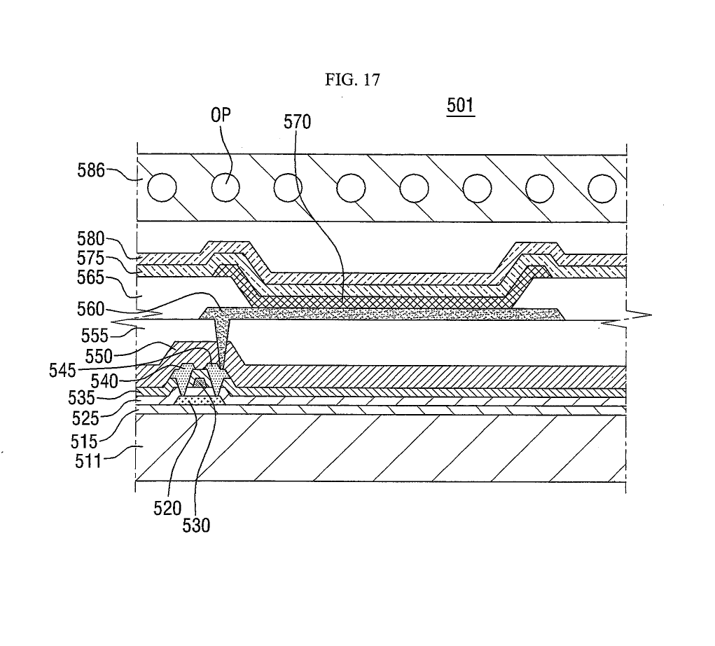

FIG. 17 is a cross-sectional view of an organic light emitting display 501 according to another embodiment of the present invention. For convenience in explanation, the same reference numerals are used for elements that are substantially the same as the elements illustrated in the above-described drawings, and duplicate explanation thereof will not be repeated.

A first substrate 511 of the organic light emitting display 501 according to another embodiment of the present invention may not include a plurality of optical patterns OP. Instead, a second substrate 586 may include the plurality of optical patterns OP.

The organic light emitting display 501 according to another embodiment of the present invention as described above may be a top emission organic light emitting display. That is, light emitted from the organic light emitting layer 570 may be output to an outside through the second substrate 586. At this time, since the light may be scattered by the plurality of optical patterns OP formed inside the second substrate 586, the side viewing angle of the organic light emitting display 501 may be improved.

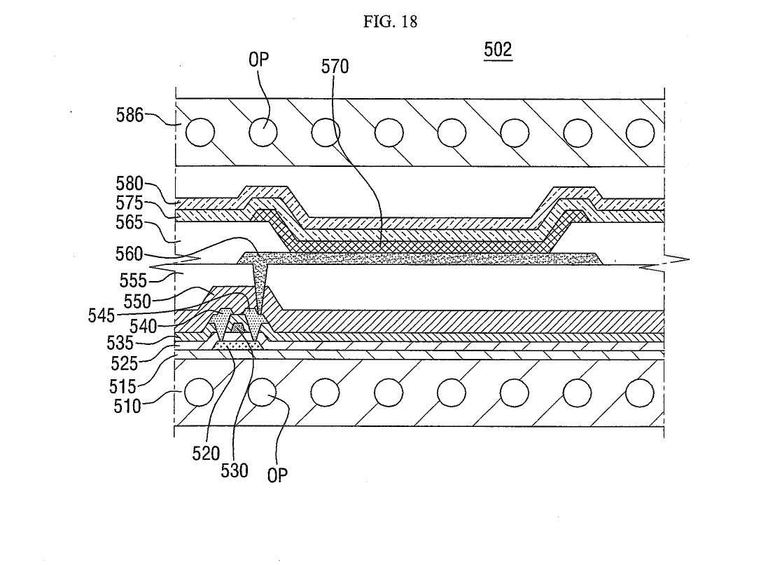

FIG. 18 is a cross-sectional view of an organic light emitting display 502 according to still another embodiment of the present invention. For convenience in explanation, the same reference numerals are used for elements that are substantially the same as the elements illustrated in the above-described drawings, and duplicate explanation thereof may not be repeated.

A first substrate 510 and a second substrate 586 of the organic light emitting display 502 according to still another embodiment of the present invention may include a plurality of optical patterns OP.

The organic light emitting display 502 according to still another embodiment of the present invention as described above may be a dual emission organic light emitting display. That is, light emitted from the organic light emitting layer 570 may be output to an outside through both the first substrate 510 and the second substrate 586. At this time, since the light may be scattered by the plurality of optical patterns OP formed inside the first substrate 510 and the second substrate 586, the side viewing angle of the organic light emitting display 502 may be improved.

Although embodiments of the present invention have been described for illustrative purposes, those skilled in the art will appreciate that various modifications, additions and substitutions are possible, without departing from the scope and spirit of the invention as disclosed in the accompanying claims, and equivalents thereof.

What is claimed is:

1. A substrate for a display device, comprising:
a base substrate; and
a plurality of first optical patterns inside the base substrate,
wherein the plurality of first optical patterns are spaced apart from each other at equal intervals along a first direction parallel to one surface of the base substrate.

2. The substrate for a display device of claim 1, wherein an interface between each of the plurality of first optical patterns and the base substrate comprises a concavo-convex shape.

3. The substrate for a display device of claim 1, wherein a refractive index of the plurality of first optical patterns is lower than a refractive index of the base substrate.

4. The substrate for a display device of claim 3, wherein the refractive index of each of the plurality of first optical patterns is increased from a center portion of each of the first optical patterns to an edge portion thereof.

5. The substrate for a display device of claim 1, wherein a transparency of the plurality of first optical patterns is lower than a transparency of the base substrate.

6. The substrate for a display device of claim 5, wherein the transparency of each of the plurality of first optical patterns is increased from a center portion of each of the first optical patterns to an edge portion thereof.

7. The substrate for a display device of claim 1, wherein the plurality of first optical patterns have a square shape.

8. The substrate for a display device of claim 7, wherein the plurality of first optical patterns are parallel to one surface of the base substrate, and spaced apart from each other at equal intervals along a second direction crossing the first direction.

9. The substrate for a display device of claim 8, wherein the plurality of first optical patterns are arranged in a matrix form.

10. The substrate for a display device of claim 1, wherein the plurality of optical patterns have a cylindrical shape.

11. The substrate for a display device of claim 10, wherein the plurality of first optical patterns are parallel to one surface of the base substrate, and extend along a second direction crossing the first direction.

12. The substrate for a display device of claim 1, further comprising a plurality of second optical patterns spaced apart from each other at equal intervals along a second direction, extending along the first direction, and crossing the plurality of first optical patterns.

13. A method for fabricating a substrate for a display device, the method comprising:
arranging an optical interferometer on one surface of a transparent substrate; and
forming a plurality of first optical patterns while moving the optical interferometer relatively to the transparent substrate,
wherein the plurality of first optical patterns are spaced apart from each other at equal intervals along a first direction parallel to one surface of the transparent substrate.

14. The method of claim 13, wherein the optical interferometer irradiates interference laser light formed through overlapping of a plurality of laser lights onto an interior of the transparent substrate.

15. The method of claim 14, wherein the interference laser light forms an interference wave in which peaks and valleys are repeated along the first direction, and
a wavelength of the interference wave is equal to a gap distance between the plurality of first optical patterns arranged in the first direction and adjacent to each other.

16. The method of claim 13, wherein a moving direction of the optical interferometer is substantially perpendicular to the first direction.

17. The method for fabricating a substrate for a display device of claim 13, wherein the optical interferometer is repeatedly in on and off states in a set period.

18. The method of claim 13, wherein the optical interferometer is in an on state during movement of the optical interferometer.

19. The method of claim 18, further comprising:
forming a plurality of second optical patterns while moving the optical interferometer relatively to the transparent substrate along the first direction after the forming of the plurality of first optical patterns,
wherein the plurality of second optical patterns are parallel to the one surface of the transparent substrate and spaced apart from each other at equal intervals along a second direction perpendicular to the first direction.

20. A display device comprising:
a first substrate;
a display element on the first substrate; and
a second substrate on the display element,
wherein the first substrate and/or the second substrate comprises a plurality of first optical patterns therein, and
the plurality of first optical patterns are spaced apart from each other at equal intervals along a first direction parallel to one surface of the first substrate or the second substrate.
